(19) United States
(12) Patent Application Publication
(10) Pub. No.: US 2017/0112240 A1
(43) Pub. Date: Apr. 27, 2017

(54) NECKLACE FOR HOLDING SMART DEVICE

(71) Applicant: Seungho LEE, Seoul (KR)

(72) Inventor: Seungho LEE, Seoul (KR)

(21) Appl. No.: 15/314,069

(22) PCT Filed: May 26, 2015
(86) PCT No.: PCT/KR2015/005234

§ 371 Date: Nov. 26, 2016

(30) Foreign Application Priority Data
May 26, 2014 (KR) 10-2014-0062985

(51) Int. Cl. A44C 15/00; H04R 1/10; A45F 5/00

(52) U.S. Cl. CPC A44C 15/003; A44C 15/005; A45F 5/00; H04R 1/1066

(57) ABSTRACT

The present invention relates to a necklace for holding a smart device, which enables a user to conveniently use a smart device even while on the move, the necklace including a coupling part, which an earphone and a smart device are fixable to or attachable/detachable from and has the function of rotating in the direction of a user's intended motion, and a distribution part, which distributes the weight of a smartphone. Since the necklace according to the present invention includes first coupling parts, to which an earphone receiver is fixable, and a second coupling part, which a smart device is attachable/detachable from, a smart device may be conveniently used even while on the move or during physical activity. In addition, the necklace of the present invention may be equipped with the distribution part for preventing the weight of a smart device from being applied to a user's neck, whereby a user may conveniently use a smart device even while on the move or during physical activity. Furthermore, the simple structure and small volume of the holding device of the present invention enables a user to conveniently carry the same. Moreover, since the necklace of the present invention can be equipped with a cradle, which is attachable/detachable from the necklace and enables adjustment of a distance or angle between a user and a smartphone, the necklace may resolve inconvenience, such as excessively bending the neck, pain in the arms, and continuously holding the smart device in hand, during use of the smart device on the subway, and the like.

### TECHNICAL FIELD

The present invention relates to the necklace for holding a smart device, and more particularly to a necklace for holding a smart device which includes a coupling part, which an earphone and a smart device or are fixable to or attachable to/detachable to/from, a distribution part distributing the weight of a smartphone, and a holder for adjusting the position of a smart device a such as a smartphone, which enables a user to conveniently use a smart device even while on the move.

### BACKGROUND ART

Encouraged by rapid advances in information technology (IT) in recent times, smart devices have been equipped with various functions. Wearable technologies are increasingly applied to smart devices to provide immediate convenience to a user by attaching or fastening a smart device and peripheral devices thereof to the user's body.

In accordance with this trend, the present invention intends to improve both portability and usability of existing smart devices by applying wearable technologies, and the product according to the present invention may free user's hands while carrying the smart devices. In addition, despite research indicating that the risk of brain tumors increases due to electromagnetic waves emitted when talking on a smartphone while placing the smartphone next the ear, there has been no particular solution except for using wireless hands-free phones up to now. Thus, the product of the present invention may become an alternative to solve health problems caused by such electromagnetic wave.

Use of smart devices (smartphones, handheld game consoles, electronic books, etc.) allowing talking on a telephone, playing games, Internet surfing, or reading book on the move is rapidly growing. However, the size of a screen of a smart device is gradually increasing due to addition of many functions to the smart device, and thus, the volume and weight of such a smart device is increasing. Accordingly, consumers experience inconvenience in carrying and manipulating smart devices. When a smart device is held with both hands upon use of the smart device, there are inconveniences that the neck is excessively bent due to structural features of the joints of the human body, and onerousness that hands cannot be freely used. Accordingly, the major advantages of a smart device that searching, talking on a telephone, playing games, and the like are possible on the move, are decreased.

Korean Patent Application Publication No. 2002-36079 discloses a hands-free necklace for a cellular phone equipped with a band member, a hands-free means, a receiving member, and a connection means. The patent document also discloses an earphone configured to be wound without tangling of a signal transmission line thereof, but does not provide a device configured such that a user can manipulate the same in a hands-free state while on the move. Korean Utility Model No. 20-462244 discloses the necklace-shaped device for holding a cellular phone, wherein a cellular phone is mounted in a groove. The utility model document discloses a device for holding a cellular phone which allows both hands to freely move. However, the holder has a structure wherein a cellular phone is fixed to the holder by mounting both sides of the cellular phone thereon. Due to such a structure, the holder has a greater volume than the cellular phone, and thus, it is very difficult to carry the holder. In addition, when a cellular phone is fixed to the holder, the center of gravity of the holder moves forward, and thus, considerable weight is applied to the neck.

### DISCLOSURE

### Technical Problem

Therefore, the present invention has been made in view of the above problems, and it is one object of the present invention to provide the necklace-type device for holding a smart device which allows immediate use of the smart device by positioning the smart device at the most convenient position at which the smart device may be more conveniently used at all times, particularly when on the move or engaged in physical activity. The present invention aims to increase both portability and usability by making a conventional smart device wearable, and freeing both hands of a user.

It is another object of the present invention to provide a device for holding a smart device to minimize harm due to electromagnetic waves emitted during use of a smart device.

It is another object of the present invention to provide a device for holding a smart device which prevents application of excessive weight to the neck when a smart device is mounted on the device for holding a smart device.

It is another object of the present invention to provide a device for holding a smart device which is equipped with a separate detachable cradle that enables adjustment of a distance or angle between a user and the smart device, and thus, may prevent the neck from being excessively bent during use of the smart device on the subway and the like, and address inconvenience of supporting the smart device by hand.

It is another object of the present invention to provide a device for holding a smart device which may facilitate detachment/attachment of a smart device from/to the necklace, minimize sway of the smart device even during physical activity, and allow free adjustment of a holding position of the smart device due to free direction change, in left, right, up, down, forward and backward directions, of the device for holding a smart device in a state in which the device for holding a smart device is worn around the neck.

It is yet another object of the present invention to provide a device for holding a smart device which may prevent tangling of an earphone cord by fixing an earphone, which is connected to the smart device, and provide a good appearance by fixing the earphone cord to the necklace string.

### Technical Solution

In accordance with one aspect of the present invention, provided is a necklace for holding a smart device including:

a necklace string forming a body;

a coupling part connected to the necklace string; and

an earphone located along the necklace string,

wherein the coupling part includes first coupling parts, to which an earphone receiver is fixable, and a second coupling part, to/from which a smart device is attachable/detachable and about which the smart device rotates.

### Advantageous Effects

As apparent from the foregoing, the present invention advantageously provides a necklace including first coupling parts, to which an earphone receiver is fixable, and a second coupling part, to/from which a smart device is attachable/detachable. Accordingly, a smart device may be conveniently used, particularly on the move or during physical activity. In addition, the necklace of the present invention can be equipped with the distribution part for preventing the weight of a smart device from being applied to the neck region, whereby a user may conveniently use a smart device even on the move or during physical activity. Furthermore, the simple structure and small volume of the holding device, i.e., the necklace, of the present invention enable a user to conveniently carry the same. Moreover, since the necklace of the present invention can be equipped with a separate cradle, which is attachable to/detachable from the necklace and enables adjustment of a distance or angle between a user and a smartphone, the necklace may resolve inconvenience, such as excessively bending the neck, pain in the arms, and continuously holding the smart device, during use of the smart device on the subway and the like.

### DESCRIPTION OF DRAWINGS

FIG. 1 illustrates the necklace for holding a smart device according to an embodiment of the present invention.

FIG. 2 illustrates an enlarged view of a coupling part illustrated in FIG. 1.

FIGS. 3 to 8 illustrate other embodiments of a coupling part of the present invention.

FIG. 9 illustrates any one of coupling parts illustrated in FIGS. 4 to 7 which is equipped with a smart device.

FIGS. 10 to 14 illustrate embodiments of a holder for adjusting the position of a smart device.

### BEST MODE

Preferred embodiments of the present invention are now described more fully with reference to the accompanying drawings. In the description of embodiments of the present invention, certain detailed explanations of related known functions or constructions are omitted when it is deemed that they may unnecessarily obscure the essence of the invention. In addition, the terms used in the specification are defined in consideration of functions used in the present invention, and can be changed according to the intent or conventionally used methods of clients, operators, and users. Accordingly, definitions of the terms should be understood on the basis of the entire description of the present specification.

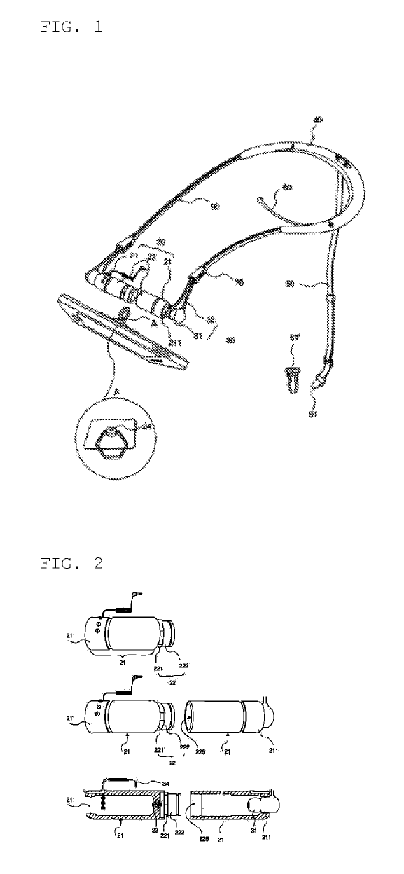

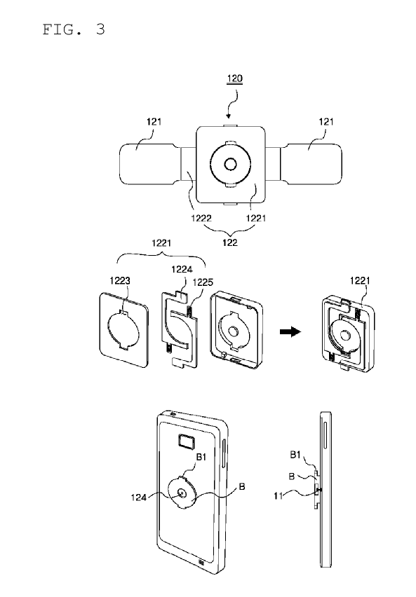

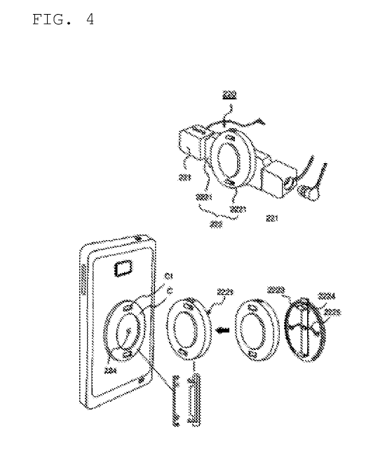

FIG. 1 illustrates the necklace for holding a smart device according to an embodiment of the present invention, FIG. 2 illustrates an enlarged view of a coupling part illustrated in FIG. 1, and FIGS. 3 to 6 illustrate other embodiments of a coupling part of the present invention. Referring to FIGS. 1 to 6, the necklace for holding a smart device of the present invention includes the necklace string 10, a coupling part 20, and an earphone 30.

The necklace string 10 may be formed in a ring shape (in an ergonomic structure) to wear the necklace for holding a smart device of the present invention around the user' s neck, and may be made of natural rubber, flexible fabric, synthetic resin, leather, a metallic or nonmetallic wire, or the like.

The coupling part 20 is connected (fastened) to the necklace string 10.

The coupling part 20 includes the first coupling parts 21 to which a receiver 31 of the earphone 30 is fixable; and a second coupling part 22 to/from which a smart device is attachable/detachable and about which the smart device rotates.

The first coupling parts 21 may be fastened to both ends of the second coupling part 22. That is, the second coupling part 22 is provided to connect the both first coupling parts 21. A first rotation means 23 is disposed between the second coupling part 22 and the first coupling parts 21, whereby the second coupling part 22 may rotate.

A first coupling part 21 may include a hole 211 to which an earphone receiver 31 is fixed.

An inside of the hole 211 may be made of, for example, a material having high friction or an elastic material or may include such a material, such that, after the earphone receiver 31 is inserted into the hole 211, the earphone receiver 31 is not separated from the hole 211. A manner in which the earphone receiver 31 is fixed to and attached to/detached from the hole 211 is not specifically limited. For example, the earphone receiver 31 is pressed to the hole 211 or fixed to the hole 211 by magnetism, easy attachment/detachment is accomplished.

The second coupling part 22 includes a fastening accessory (A, B, or C), which is attached to a smart device, and a coupling part coupled to the fastening accessory.

The fastening accessory may be attached to a rear surface of a smart device or smart device case or may be connected thereto via a rivet, a bolt, a pin, or the like. In addition, the fastening accessory has a rotatable structure, a foldable structure, etc. For example, the fastening accessory may have a rotation function as a rotation means of the second coupling part 22 described below. In addition, the fastening accessory may have a ring structure and may have a structure wherein coupling is performed in one step.

FIG. 2 illustrates an enlarged view of the coupling part 20 when the fastening accessory of the smart device has a ring structure A.

Referring to FIG. 2, the second coupling part 22 includes a coupling part 221, into which the ring A is inserted or placed, and a protrusion 222, which extends from the coupling part 221. At the first coupling part 21, a fixing part 225, into which the protrusion 222 is inserted and to which the protrusion 222 is fixed, is formed.

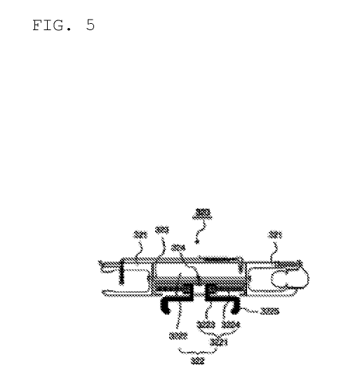

The first rotation means 23 is provided between the second coupling part 22 and the first coupling part 21. As the first rotation means 23, a rotational ball, a rotational pin, or a rotor may be used. FIG. 2 illustrates a rotational pin as a first rotation means. Referring to FIG. 2, the first rotational pin includes heads at both ends thereof and thus controls detachment and rotation of the pin. Referring to FIG. 5, a first rotation means 323 penetrates a second coupling part 322, and detachment and rotation of a pin of the first rotation means 323 are controlled by heads formed at both ends of the first rotation means 323.

Referring to FIG. 2, the ring A for holing a smart device may be a circular or polygonal ring, for example, a circular ring, a ring having both circular and polygonal shapes, or a polygonal ring such as a triangular ring, a quadrangular ring, a hexagonal ring, an octagonal ring, or the like. In addition, the ring A for holing a smart device has the same shape as the coupling part 221 which corresponds to and is fastened to the ring A.

FIG. 2 illustrates a coupling part 221′ including a slit. The ring A corresponding to the coupling part 221′ may include a protrusion which is inserted into the slit. When the protrusion is fastened to the slit, a smart device may be stably fixed and may be easily rotated. In addition, a call button, a volume control button, etc. may be applied using known technologies.

FIGS. 3 and 4 illustrate other embodiments of the coupling part of the present invention.

Referring to FIGS. 3 and 4, coupling parts 120 and 220 respectively include first coupling parts 121 and 221 and second coupling parts 122 and 222. Also in the cases of FIGS. 3 to FIG. 4, a first rotation means (not shown) is provided between the second coupling part 122 and the first coupling parts 121 and between the second coupling part 222 and the first coupling part 221. The first rotation means (not shown) may be formed in the same shape as the first rotation means 23 of FIG. 2.

The second coupling part 122 may include a supporter 1222 for fixing the coupling part 1221, and the second coupling part 222 may include a supporter 2222 for fixing the coupling part 2221.

A coupling accessory B or C directly coupled with the smart device may include a second rotation means 124 or 224, or the coupling accessory B or C may be formed between the coupling part 1221 or 2221 and the supporter 1222 or 2222 to rotate the coupling part 1221 or 2221.

The coupling part 1221 or 2221 may be attached to/detached from the fastening accessory B or C, which is attached to a smart device, in one step.

FIGS. 5, 6, 7, and 8 illustrate other embodiments of the coupling part of the present invention.

Referring to FIGS. 5, 6, 7, and 8, a coupling part 320,420,520, or 620 is directly fastened to a smart device, without the fastening accessory A, B, or C directly attached to a smart device.

In the coupling part 320, 420, 520, or 620, a second rotation means 324, 424, or 624 is formed between a fastener 3221, 4221, 5221, or 6221 and a supporter 3222, 4222, 5222, or 6222 and thus may rotate the fastener 3221, 4221, 5221, or 6221.

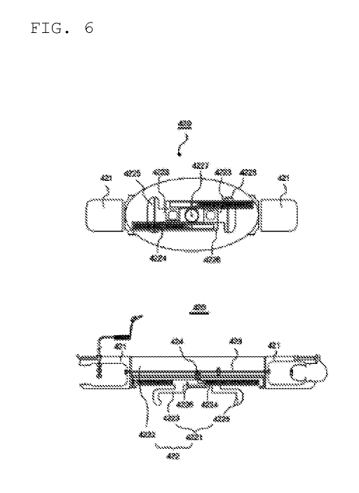

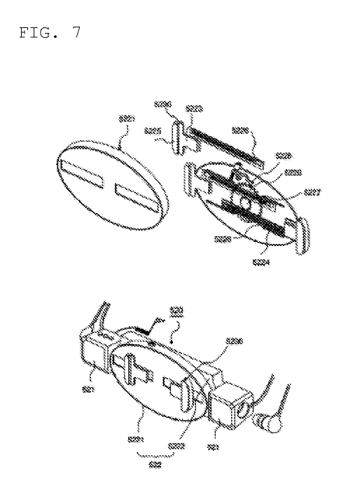

A rotational pin having the same structure (function) as the first rotation means 323 or 423 and the second rotation means 324 or 424 illustrated in FIGS. 5 and 6 may also be used in the embodiments of FIGS. 3, 4, 7, and 8.

As the second rotation means 324, 424, or 624, a known rotational ball or rotor may be used.

Referring to FIG. 3, the coupling part 1221 may include engaged grooves 1223 into which the engaging protrusions B1 formed at the fastening accessory B for a smart device are inserted, thereby being fixed; bars 1224 opening and closing the engaged grooves; and elastic parts 1225 returning the bars 1224, which have been moved by external force, to original positions.

Referring to FIG. 4, a coupling part 2221 may include engaging protrusions 2223 inserted into and fixed to grooves Cl of the fastening accessory C for a smart device; a bar 2224 configured to fix the engaging protrusions; and an elastic part 2225 configured to return the bar, which moves by external force, to an original location.

Referring to FIG. 5, a coupling part 320 includes first coupling parts 321, a second coupling part 322, and a first rotation means 323.

The second coupling part 322 may include a fastener 3221 pressing both sides of a smart device and thus fixing the same; the supporter 3222 fixing the fastener 3221; and a second rotation means 324 rotating the fastener 3221.

The fastener 3221 includes a pair of holders 3223 which slide from side to side and at an end of each of which an engaging protrusion 3225 is formed; and a pair of elastic parts 3224 providing restoring force to the holders 3223.

Referring to FIG. 6, a coupling part 420 includes the first coupling parts 421, a second coupling part 422, and a first rotation means 423. The second coupling part 422 may include a fastener 4221 to/from which the smart device is attached/detached; a supporter 4222 to which the fastener is fixed; and a second rotation means 424 configured to rotate the fastener 4221.

The fastener 4221 includes two holders 4223 which slide from side to side, at an end of each of which an engaging protrusion 4225 is formed, and which are provided at opposite sides of the fastener 4221; a pinion 4227 controlling a moving distance of the two holders 4223 such that the two holders 4223 slide by the same distance; a sliding bar 4226 which slides from side to side in engagement with the pinion 4227 and one end of which is coupled to one of the holders 4223; and elastic parts 4224 providing restoring force for supporting a smart device to the holders 4223.

Referring to FIG. 7, a coupling part 520 includes first coupling parts 521, a second coupling part 522, and a first rotation means (not shown). The second coupling part 522 may include a fastener 5221 attached to/detached from the smart device; a supporter 5222 to which the fastener 5221 is fixed; and a second rotation means (not shown) configured to rotate the fastener 5221.

The fastener 5221 includes two holders 5223 which slide from side to side, elastic materials 5230 enabling a smart device to be supported by engaging protrusions 5225 at ends thereof, and located at opposite sides; a pinion 5227 controlling a moving distance such that the two holders 5223 slide by the same distance; a sliding bar 5226 which slides from side to side in engagement with the pinion and one and of each of which is connected to each of the holders 5223; and elastic parts 5224 providing force to separate a smart device from the holders 5223. The fastener 5221 includes a fixing pin 5228 controlling rotation of the pinion 5227. The fixing pin 5228 may control rotation of the pinion 5227 by selectively engaging with teeth of a gear 5229 that is coaxially coupled with the pinion 5227.

Referring to FIGS. 6 and 7, the necklace according to the present invention may control a moving distance such that the two holders 4223 or 5223 slide by the same distance, and thus, a smart device may be positioned at the center of the second coupling part 422 or 522.

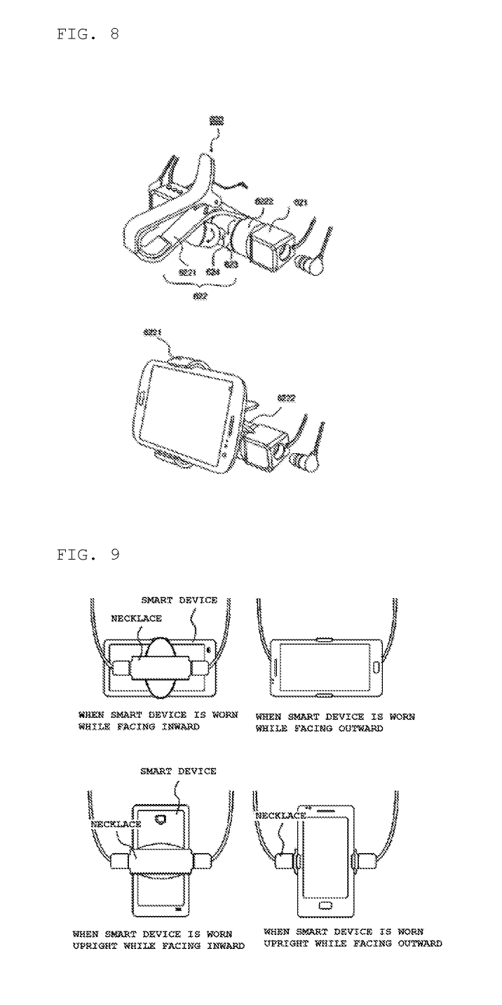

Referring to FIG. 8, a coupling part 620 includes a first coupling part 621, a second coupling part 622, a first rotation means 623, and a second rotation means 624.

The second coupling part 622 may include a pair of tongs 6221 configured to press both side of a smart device.

The pair of tongs 6221 is fixed to the second coupling part 622, and thus, may press and fix a smart device. The pair of tongs 6221 has a simple structure. Particularly, the pair of tongs 6221 is effective in that it may fix a smart device without a separate fastening accessory.

The necklace for holding a smart device may further include a hanger 40. The hanger 40 may cover and protect a portion of the necklace string and a portion of a cord of the earphone, house a microphone, further include a function of controlling the length of the necklace, prevent the necklace from shaking from side to side when worn about a user's neck, absorb shock, and improve wearing stability. The hanger 40 preferably has a round shape corresponding to lines of the human body, such as lines of a user's neck and shoulder.

The hanger 40 may be made of natural rubber; fabric having flexibility; synthetic resin; fiber; a leather, metallic, or nonmetallic wire; or the like.

The necklace for holding a smart device may include a distribution part 50 for distributing the weight of a smartphone applied upon loading of the smartphone onto the necklace.

Referring to FIG. 1, the distribution part 50 has a predetermined length. In addition, one end of the distribution part 50 is connected to the necklace string or the hanger 40 and, at another end of the distribution part 50, fasteners 51 and 51′ may be formed. The distribution part 50 may have a belt, string, or band (suspender) form. The distribution part 50 may extend to a user's back or side and thus may be fixed to a belt line, a belt ring, or the like of the user. The distribution part 50 may be formed in a shape of a single band as illustrated in FIG. 1, in a shape of one or more strings, bands, or belts, or in an I-shape, II-shape, X-shape, Y-shape, or inverted Y-shape.

The fasteners 51 and 51′ may preferably have a tong structure or a stable ring structure. When the fasteners 51 and 51′ are fixed along a belt line of a user or to a belt ring, the weight of a smart device is distributed to the distribution part 50 and the waistband. Accordingly, most of the weight applied to a user's neck may be naturally distributed to the waistband or pants.

The necklace for holding a smart device of the present invention may include a microphone 60, the length of which may be controlled. Referring to FIG. 1, a portion of the microphone 60 may be disposed inside the hanger 40, whereby a user may arbitrarily control the length of the microphone 60. The microphone 60 may be a ball-head microphone fixable to a predetermined position.

The necklace for holding a smart device includes an earphone jack 34 connected to a smart device, and a tightening part 70 enabling an earphone cord 32 to be tightly fixed to the necklace string 10.

The necklace of the present invention may have a detachable structure in a male and female coupling manner at one surface of the earphone cord 32 corresponding to one surface of the necklace string 10.

More particularly, the detachable structure includes a groove that is formed at any one surface (for example, one surface of the earphone cord 32); and a protrusion that is formed at another surface (for example, one surface of the necklace string 10) corresponding to the surface and is engaged with the groove. Coupling between the groove and the protrusion due to compression therebetween, and separation thereof may be accomplished through movement of the tightening part 70.

FIG. 9 illustrates any one of the coupling parts illustrated in FIGS. 4 to 7 which is equipped with a smart device. Referring to FIG. 9, the necklace of the present invention allows free control of a holding position of a smart device inwardly or outwardly even when the smart device is laid flat or stood upright.

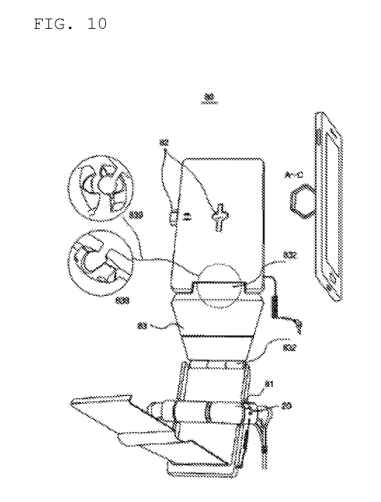

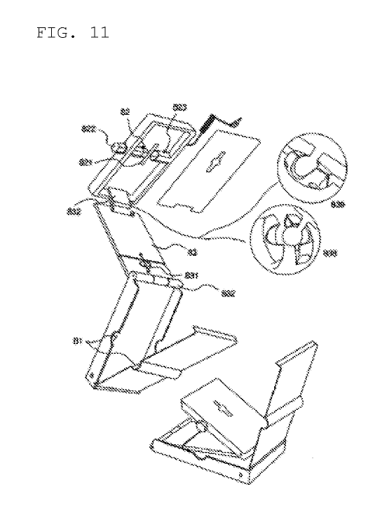

The necklace for holding a smart device may further include a cradle 80 for adjusting the position of a smart device. FIGS. 10 to 14 illustrate embodiments of the holder for adjusting the position of a smart device.

Referring to FIGS. 10 to 13, the cradle 80 for adjusting the position of a smart device includes a first connector 81 which is fastened to or fixes the coupling part 20; a second connector 82 which is fastened to a smart device or the fastening accessory A, B, or C for a smart device; and a deformation part 83 which is formed between the first connector 81 and the second connector 82 and may adjust rotation of the cradle 80 or the length thereof.

Referring to FIG. 11, the first connector 81 may be formed in a groove structure shape such that the coupling part 20 is located at and fixed to the groove structure. The groove structure may be varied depending upon the shape of the coupling part.

The coupling part for a smart device, for example a fastening accessory having a ring structure, may be fixed to the second connector 82. The second connector 82 may include a slit 822 into which a ring of the fastening accessory may be inserted, and a fastening structure in an on-off manner, which has a shape corresponding to the shape of the ring, may be mounted and fixed by pushing the slit 822, and may be separated by pushing the slit 822 again.

The deformation part 83 includes a rotational pin 831 and thus is rotatable. In addition, the deformation part 83 includes upper and lower hinges 832 respectively connected to the first and second connectors 81 and 82, and thus, the height and angle of the cradle 80 may be controlled. A plurality of plate structures constituting the deformation part 83 may be connected to each other by the rotational pin 831.

The structure of the hinge 832 or the pin 831 may be substituted with a ball and head structure 838 or 839. Accordingly, a distance or angle between a user and the cradle of the present invention may be controlled using the deformation part.

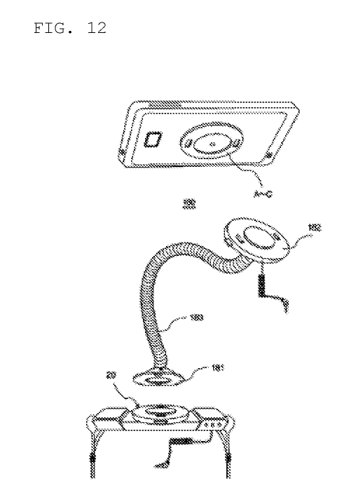

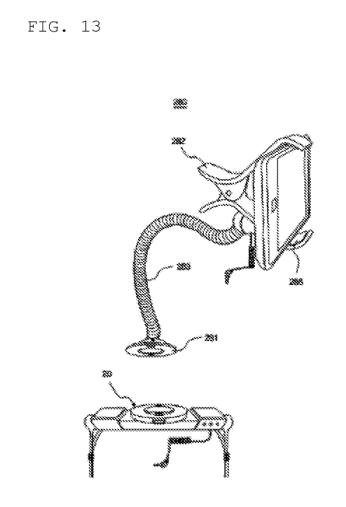

Referring to FIG. 12, the holder for adjusting the position of a smart device 180 includes a first connector 181, a second connector 182, and a deformation part 183.

Description of the coupling part 20 fastened to the first connector 181 and the fastening accessory A, B, or C for a smart device fastened to the second connector 182 is the same as that described in FIG. 4.

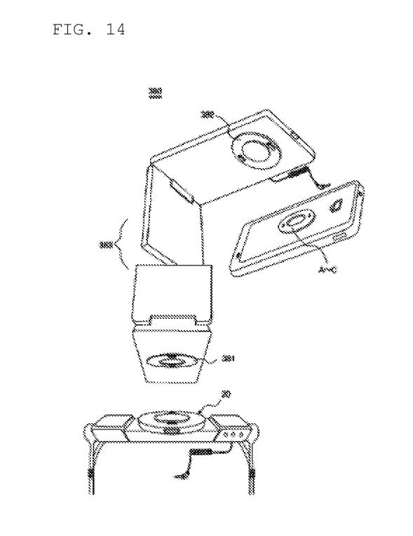

Referring to FIG. 13, the holder for adjusting the position of a smart device 280 includes a first connector 281, a second connector 282, and a deformation part 283.

Description of the coupling part 20 fastened to the first connector 281 and the fastening accessory A, B, or C for a smart device fastened to the second connector 182 is the same as that described in FIG. 4.

The first connector 181 or the second connector 182 may be coupled with a second fastener or the fastening accessory A, B, or C for a smart device in one step or by means of tongs 282 and 285.

The deformation parts 183 and 283 may be made of a flexible plastic material allowing free shape deformation, or a metallic material.

Referring to FIG. 14, the holder for adjusting the position of a smart device 380 includes a first connector 381, a second connector 382, and a deformation part 383.

Description of the coupling part 20 fastened to the first connector 381 and the fastening accessory A, B, or C for a smart device fastened to the second connector 382 is the same as that described in FIG. 4.

It will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

### INDUSTRIAL APPLICABILITY

By using the necklace of the present invention, a smart device may be conveniently used even while on the move or in action. A holding device of the present invention has a simple structure and small volume, and thus, a user may conveniently carry the same.

1. A necklace for holding a smart device, comprising:
a necklace string forming a body;
a coupling part connected to the necklace string; and
an earphone located along the necklace string,
wherein the coupling part comprises a second coupling part to/from which a smart device is attachable/detachable and about which the smart device rotates.

2. The necklace according to claim 1, wherein the coupling part comprises first coupling parts, to which an earphone receiver is fixable.

3. The necklace according to claim 2, wherein the first coupling parts are fastened to both ends of the second coupling part, and a first rotation means is provided between the second coupling part and the first coupling parts and thus the second coupling part rotates.

4. The necklace according to claim 2, where in the first coupling parts comprises a hole to which the earphone receiver is fixed.

5. The necklace according to claim 1, wherein the second coupling part comprises a coupling part which couples with a fastening accessory attached to a smart device; and a second rotation means which rotates the coupling part or at which the fastening accessory rotates.

6. The necklace according to claim 1, wherein the second coupling part comprises a fastener which compresses and fixes both side of a smart device; and a second rotation means which rotates the fastener.

7. The necklace according to any one of claims 3, 5, and 6, wherein the first or second rotation means is a rotational ball, a rotational pin, or a rotor.

8. The necklace according to claim 5, wherein, when the fastening accessory for a smart device has a ring structure, the second coupling part comprises a coupling part in which a ring of a smart device is inserted or mounted; a protrusion expanding from the coupling part;
and a fixing part fastened to the protrusion.

9. The necklace according to claim 5, wherein the coupling part is coupled, in one step, with the fastening accessory attached to a smart device, the second coupling part comprises a supporter for fixing the coupling part, and the second rotation means is formed between the coupling part and the supporter and thus rotates the coupling part.

10. The necklace according to claim 9, wherein the coupling part comprises engaged grooves into engaging protrusions formed at the fastening accessory for a smart device are inserted, thereby being fixed; bars opening and closing the engaged grooves; and elastic parts returning the bars, which have been moved by external force, to original positions.

11. The necklace according to claim 9, wherein the coupling part comprises engaging protrusions inserted into and fixed to grooves of the fastening accessory for a smart device; a bar configured to fix the engaging protrusions; and an elastic part configured to return the bar, which moves by external force, to an original location.

12. The necklace according to claim 6, wherein the fastener comprises a pair of holders which slide from side to side and at an end of each of which an engaging protrusion is formed; and a pair of elastic parts providing restoring force to the holders.

13. The necklace according to claim 6, wherein the fastener has a tong structure wherein both side of a smart device is compressed.

14. The necklace according to claim 6, wherein the fastener comprises two holders which slide from side to side, at an end of each of which an engaging protrusion is formed, and which are provided at opposite sides of the fastener; a pinion controlling a moving distance of the two holders such that the two holders slide by the same distance; and elastic parts providing restoring force for supporting a smart device to the holders.

15. The necklace according to claim 6, wherein the fastener comprises two holders which slide from side to side, at an end of each of which an engaging protrusion is formed, and which are provided at opposite sides of the fastener; an elastic pressing part attached to the engaging protrusion; a pinion controlling a moving distance of the two holders such that the two holders slide by the same distance; a fixing pin determining rotation of the pinion; and elastic parts providing restoring force to the holders.

16. The necklace according to claim 1, wherein the necklace comprises a distribution part for distributing a weight of a smartphone applied upon loading of the smartphone onto the necklace, wherein the distribution part has a predetermined length, one end of the distribution part is connected to the necklace string, and fasteners are formed at another end of the distribution part.

17. The necklace according to claim 1, wherein the necklace covers and protects a portion of the necklace string and a portion of a cord of the earphone, and comprises a hanger having a round shape.

18. The necklace according to claim 17, wherein a length-controllable microphone is formed at the hanger of the necklace and a supporter and wire of the microphone is movable from an interior of the hanger to an outside.

19. The necklace according to claim 1, wherein one surface of the earphone is coupled to or separated from one surface of the necklace string along a length direction of the necklace, thereby preventing tangling of a cord of the earphone.

20. The necklace according to claim 1, wherein the necklace further comprises an attachable/detachable cradle, wherein the cradle comprises a first connector which is fastened to or fixes the second coupling part; a second connector which is fastened to a fastening accessory for a smart device or fixes the coupling part;
and a deformation part which is formed between the first and second connectors rotation and rotation or length of which is adjustable.

21. The necklace according to claim 20, wherein the first or second connector has a coupling structure wherein the first or second connector is coupled with a second fastener or the fastening accessory for a smart device in one step, or has a tong structure.
